(19) United States
(12) Patent Application Publication
(10) Pub. No.: US 2012/0173660 A1
(43) Pub. Date: Jul. 5, 2012

(54) Real-Time Power Cost Feed

(75) Inventors: Joseph Rorai, Kanata (CA); Kin-Yee Wong, Ottawa (CA)

(73) Assignee: ALCATEL-LUCENT CANADA INC., Kanata (CA)

(21) Appl. No.: 12/984,026

(22) Filed: Jan. 4, 2011

(51) Int. Cl. G06F 15/16; G06F 1/26

(52) U.S. Cl. 709/217; 713/310

(57) ABSTRACT

A method and apparatus are provided in which a new input to a telecommunications node is provided, namely the real-time cost of power. By providing this information, the node may make more informed decisions as to power cost of various options. For example, the node may alter its operating parameters based on the current cost of power to implement various features. The real-time cost of power is provided to the node by the power provider. The real-time cost of the power is provided to the node using any method, such as by packets through a dedicated interface of the node, packets through a UDP port, or as packets over the electricity grid. The telecommunications node is just one example of end user equipment, and the real-time cost of power may be provided to any power-consuming equipment.

### FIELD OF THE INVENTION

This invention relates to provision of power cost information to power-consuming equipment in real-time.

### BACKGROUND OF THE INVENTION

Energy and power consumption are increasingly becoming a significant business issue as energy costs and environmental impact are becoming more important in business models. At the same time, the cost of providing energy may vary. The latter is becoming more common as utilities attempt to address finite energy generation by reducing demand for peak energy. The cost of energy may vary with time and/or geography. For example, there is often less demand for electricity late at night than in the middle of the day, and in an attempt to shift consumption of electricity to off-peak hours utilities may lower the cost of the electricity at night and raise the cost of the electricity during the day.

Some power-consuming equipment has different features and abilities that can be implemented. For example, a telecommunications node may be able to vary its bandwidth processing capacity, requiring different amounts of memory and processing power to support the different amounts of bandwidth. As another example, different paths through a telecommunication network may be chosen. These different abilities may use different amounts of power.

A method which allowed more information to be taken into account when deciding which features of a piece of equipment to implement would allow more cost-efficient operation of the equipment, and allow reduction of power consumption at peak times.

### SUMMARY OF THE INVENTION

According to one aspect, a method of providing real-time cost of power to power-consuming equipment is provided. The real-time cost of power is fed as an input to the power-consuming equipment. The power-consuming equipment may be a telecommunications node.

The real-time cost of power may be embedded in a power cost packet, and the power cost packet is delivered to the power-consuming equipment through the Internet. In one embodiment, a client within the power-consuming equipment registers with a server by sending a registration packet to the server over the Internet. The server adds the client to a list of clients if the client is not already present in the list. The server generates the power cost packet so as to contain the current real-time cost of power provided by a utility company associated with the server, and transmits the power cost packet over the Internet to each client in the list.

The invention allows power-consuming equipment to take the real-time cost of power into account when making decisions as to which of various features or configurations to implement. The cost of power is provided to power-consuming equipment in real-time. The power-consuming equipment may ignore this information, but may also implement features which minimize the cost of power when the cost rises above a threshold.

### BRIEF DESCRIPTION OF THE DRAWINGS

The features and advantages of the invention will become more apparent from the following detailed description of the preferred embodiment(s) with reference to the attached figures, wherein:

FIG. 1 is a portion of a telecommunication network and power network according to one embodiment of the invention; and

FIG. 2 is a diagram of two packet structures according to one embodiment of the invention.

It is noted that in the attached figures, like features bear similar labels.

### DETAILED DESCRIPTION OF THE PREFERRED EMBODIMENTS

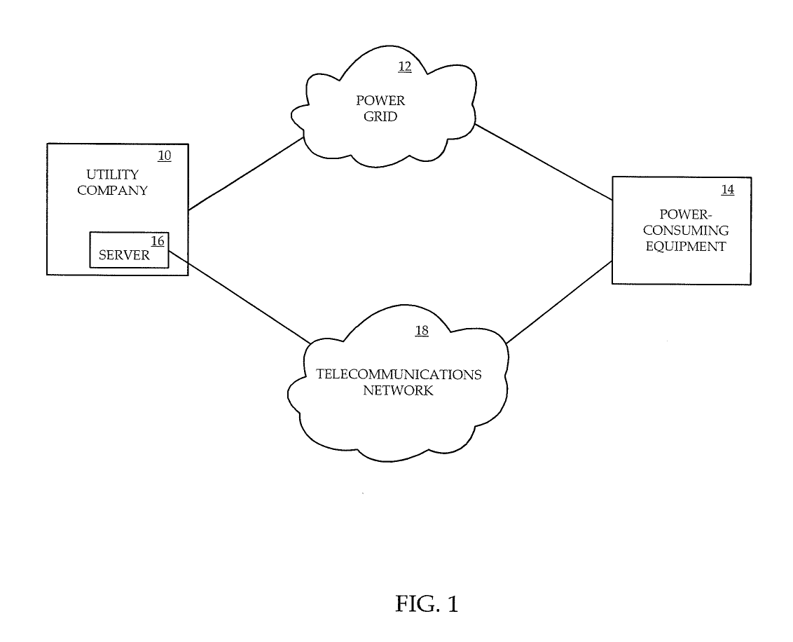

Referring to FIG. 1, a portion of a telecommunication network and power network according to one embodiment of the invention is shown. A utility company 10 acts as the power provider, providing power through a grid 12 to a power-consuming equipment 14, such as a telecommunications node. The grid 12 is usually a usual power grid used to transmit and distribute electricity throughout a region. The utility company 10 also includes a server 16. The server 16 is in communication with the power-consuming equipment 14 through a telecommunications network 18.

Broadly, the real-time cost of power provided to the power-consuming equipment 14 is fed to the power-consuming equipment 14. The real-time cost of power provided to the power-consuming equipment 14 may be provided in any of a number of ways.

In the embodiment shown in FIG. 1, the power-consuming equipment 14 contains a network connection for receiving packets from the Internet, such as an Ethernet connection. For example many telecommunication nodes are connected to the Internet, either directly or indirectly, and packets containing clock synchronization information are regularly sent to the telecommunication node in accordance with NTP or IEEE 1588v2. In this embodiment, the real-time cost of power is embedded in one or more packets, and the real-time cost of power is fed to the power-consuming equipment 14 by delivering the one or more packets to the power-consuming equipment 14. The power-consuming equipment 14 identifies packets arriving through its network connection. The payload of any packets that are identified as containing power-cost information are used by the power-consuming equipment 14 to update its knowledge of the cost of the power used by the user equipment.

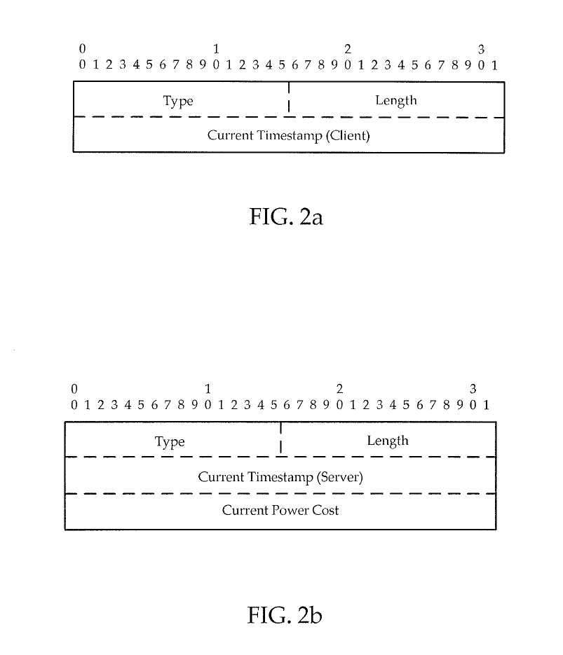

For example, a Power Cost client is located on the power-consuming equipment 14 and communicates through an IP network with a Power Cost server, which may be located at a utility company 10 or elsewhere but in either case is associated with the utility company 10. The Power Cost client registers with the Power Cost server by sending a registration packet to the Power Cost server using a predefined UDP port. The Power Cost client continues sending registration packets on a regular basis in order to remain registered. An authentication handshake may be used for security purposes. An example structure of a registration packet is shown in FIG. 2a. The Power Cost client may also deregister with the Power Cost server by sending a deregistration packet to the Power Cost server over the Internet, the deregistration packet having a specific value in the Type field.

When the Power Cost server receives a registration packet (identified by the Type field), the Power Cost server adds the Power Cost client to its list of registered clients if the Power Cost client is not already listed. The Power Cost server generates a power cost packet so as to contain the current real-time cost of power provided by the utility company associated with the server, and transmits the power cost packet over the Internet to all registered clients as defined by the list of registered clients. The Power Cost server sends the power cost packet to a fixed UDP port. Power cost packets are sent periodically and upon a power cost change. The power cost packets may be encrypted for security purposes. An example structure of a power cost packet is shown in FIG. 2b. If the Power Cost server receives a deregistration packet from a Power Cost client, it removes that client from the list of registered clients.

As an alternative, the Power Cost server can transmit the power cost packets to each listed client to a UDP port from which the respective registration packet arrived. In such an embodiment, the source UDP port of the registration packets is stored in association with the clients.

In one embodiment, the Power Cost server periodically transmits cost summary packets, as defined by a specific value of the Type field. Such packets provide a historical list of the cost of power. As an example, the Power Cost server sends a cost summary packet to the listed clients every twenty-four hours, each cost summary packet listing the power cost for every hour over the previous twenty-four hour period. The structure of such a packet would be similar to that shown in FIG. 2b, but there would be multiple timestamps and corresponding power cost fields.

When the Power Cost client receives a power cost packet on the known UDP port, the Power Cost client extracts the power cost from the packet. This power cost may then be used by the power-consuming equipment 14, such as by providing the power cost as an input to an algorithm that configures the power-consuming equipment 14 according to desired power usage policies.

Possible values of the Type field of the packets are:

01—client registration packet

02—client deregistration packet

03—current power cost packet

04—cost summary packet

As another example, the power cost information is sent to the power-consuming equipment 14 wirelessly. In such an embodiment, the network 18 is either not used or does not exist. The power-consuming equipment 14 includes a circuit card or other means to receive wireless signals. The real-time cost of power is fed to the power-consuming equipment 14 by including the real-time cost of power in wireless signals which are then received by the power-consuming equipment 14. This embodiment is advantageous if the utility company 10 does not have Internet access, in which case the utility company 10 can transmit the power cost information wirelessly.

As another example in which the network 18 is either not used or not present, a dedicated wireline allows communication between the utility company 10 and the power-consuming equipment 14. In such an embodiment, a direct link between the utility company 10 and the power-consuming equipment 14 exists. The power-consuming equipment 14 may have a dedicated port through which communications about the real-time cost of power is received, such as directly to the utility company 10. The real-time cost of power is transmitted over the dedicated wireline and fed to the power-consuming equipment through the dedicated port.

As another example in which the network 18 is either not used or not present, power line communication can be used to provide the power-cost information over the grid 12. The utility company 10 provides real-time cost of power to the power-consuming equipment 14 over the grid 12, along with the power used by the power-consuming equipment 14. The power-consuming equipment 14 is equipped to receive the power-cost information, for example being equipped to process Broadband over Power Line communications.

In one embodiment, the real-time cost of power provided by the utility company is not provided by the utility company itself, but rather by a separate entity. For example, a regulator such as a government agency may regulate the cost of the power and feed such information to the power-consuming equipment 14. In general, the power-consuming equipment 14 is fed power-cost information by some other entity, whether the other entity is the producer of the power used by the power-consuming equipment 14 or is a third party.

The power provider has been described as a utility company. Alternatively the power provider may be any entity that provides power to customers, most often through the grid 12 but possibly independently of the grid 12, as long as the cost of the power provided by the power provider is available in real-time and fed to the power-consuming equipment 14. For example, the power provider may be a generator of electricity that provides such electricity to user equipment within the same organization but at a cost that must be budgeted for by the department which owns the user equipment.

The power-consuming equipment has been described using a telecommunication node as an example. The power-consuming equipment may alternatively be any equipment, and not be limited to telecommunications equipment. For example, the power-consuming equipment could be a server in a server farm. As another example, the power-consuming equipment could be a home appliance such as a dishwasher connected to a home communication network. In general, an entity such as the power provider provides the real-time cost of the power to the power-consuming equipment.

The embodiments presented are exemplary only and persons skilled in the art would appreciate that variations to the embodiments described above may be made without departing from the spirit of the invention. The scope of the invention is solely defined by the appended claims.

I/We claim:

1. A method of providing real-time cost of power to power-consuming equipment, comprising:
feeding the real-time cost of power as an input to the power-consuming equipment.

2. The method of claim 1 wherein feeding the real-time cost of power comprises:
embedding the real-time cost of power in a power cost packet; and
delivering the power cost packet to the power-consuming equipment through the Internet.

3. The method of claim 2 comprising:
a client within the power-consuming equipment registering with a server by sending a registration packet to the server over the Internet;
the server adding the client to a list of clients if the client is not already present in the list;
the server generating the power cost packet so as to contain the current real-time cost of power provided by a utility company associated with the server; and
the server transmitting the power cost packet over the Internet to each client in the list.

4. The method of claim 3 wherein the server delivers one such power cost packet periodically and upon a change in the real-time cost of power.

5. The method of claim 3 wherein the power-consuming equipment is a telecommunications node.

6. The method of claim 3 wherein the registration packet is sent to a predefined UDP port on the server, and the power cost packet is sent to a predefined UDP port on the client.

7. The method of claim 3 wherein the registration packet is sent to a predefined UDP port on the server, and the power cost packet is sent to a UDP port on the client from which the registration packet came.

8. The method of claim 1 wherein the power-consuming equipment includes a circuit card able to receive wireless signals, and wherein feeding the real-time cost of power comprises:
including the real-time cost of power in wireless signals; and
transmitting the wireless signals to the power-consuming equipment.

9. The method of claim 1 wherein the power-consuming equipment includes a port dedicated to receiving communications over a dedicated wireline from an entity providing the real-time cost of power, and wherein feeding the real-time cost of power comprises feeding the real-time cost of power to the power-consuming equipment via the port.

10. The method of claim 1 wherein feeding the real-time cost of power comprises transmitting the real-time cost of power over a power grid through which the power-consuming equipment receives power.

11. The method of claim 1 wherein the power-consuming equipment is a telecommunications node.

12. The method of claim 11 wherein feeding the real-time cost of power comprises:
embedding the real-time cost of power in at least one packet; and
delivering the at least one packet to the telecommunications node through the Internet.

13. The method of claim 11 wherein the telecommunications node includes a circuit card able to receive wireless signals, and wherein feeding the real-time cost of power comprises:
including the real-time cost of power in wireless signals; and
transmitting the real-time cost of power to the telecommunications node via the wireless signals.

14. The method of claim 11 wherein the telecommunications node includes a port dedicated to receiving communications over a dedicated wireline from an entity providing the real-time cost of power, and wherein feeding the real-time cost of power comprises feeding the real-time cost of power to the telecommunications node via the port.

15. The method of claim 11 wherein feeding the real-time cost of power comprises transmitting the real-time cost of power over a power grid through which the power-consuming equipment receives power.
